(19) United States
(12) Patent Application Publication
(10) Pub. No.: US 2026/0081294 A1
(43) Pub. Date: Mar. 19, 2026

(54) CASE FOR SECONDARY BATTERY AND SECONDARY BATTERY INCLUDING SAME

(71) Applicant: SAMSUNG SDI CO., LTD., Yongin-Si (KR)

(72) Inventor: Dong Bok YANG, Yongin-Si (KR)

(21) Appl. No.: 19/225,839

(22) Filed: Jun. 2, 2025

(30) Foreign Application Priority Data
Sep. 13, 2024 (KR) 10-2024-0125878

(51) Int. Cl. H01M 50/342; H01M 50/119; H01M 50/159; H01M 50/169; H01M 50/55

(52) U.S. Cl. CPC H01M 50/3425; H01M 50/119; H01M 50/159; H01M 50/169; H01M 50/55; H01M 2200/20

(57) ABSTRACT

A case for a secondary battery, includes: a body including an accommodation portion having one opened end in a first direction to accommodate an electrode assembly, and a flange portion extending from the opened end in a direction different from the first direction; a cover welded to the flange portion to seal the opened end of the accommodation portion; and a welded portion of the flange portion and the cover. The welded portion includes a venting portion to be ruptured by an internal pressure of the accommodation portion sealed by the cover.

### CROSS-REFERENCE TO RELATED APPLICATION

The present application claims priority to and the benefit of Korean Patent Application No. 10-2024-0125878, filed on Sep. 13, 2024, in the Korean Intellectual Property Office, the entire disclosure of which is incorporated by reference herein.

### BACKGROUND

### 1. Field

Aspects of embodiments of the present disclosure relate to a case for a secondary battery, and a secondary battery including the case.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

If secondary batteries are exposed to high-temperature environments or are short-circuited, swelling may occur as gas is generated inside the case due to decomposition of the electrolyte contained in the case and electrode reactions. This may cause the case for the secondary battery to rupture, resulting in a fire or an explosion due to a thermal runaway.

The above information disclosed in this Background section is for enhancement of understanding of the background of the present disclosure, and therefore, it may contain information that does not constitute related (or prior) art.

### SUMMARY

Embodiments of the present disclosure may be directed to a case for a secondary battery that may prevent or substantially prevent a thermal runaway due to an increase in an internal pressure resulting from abnormal behavior (e.g., non-ideal behavior) of the secondary battery, and a secondary battery including the case.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

According to one or more embodiments of the present disclosure, a case for a secondary battery includes: a body including an accommodation portion having one opened end in a first direction to accommodate an electrode assembly, and a flange portion extending from the opened end in a direction different from the first direction; a cover welded to the flange portion to seal the opened end of the accommodation portion; and a welded portion of the flange portion and the cover. The welded portion includes a venting portion configured to be ruptured by an internal pressure of the accommodation portion sealed by the cover.

In an embodiment, a remaining portion of the welded portion, excluding the venting portion, may include a plurality of first weld beads, and the venting portion may include a plurality of second weld beads having a weaker joining strength than that of the first weld beads.

In an embodiment, some of the second weld beads may protrude toward a center of the cover, or may protrude in an opposite direction with respect to the center of the cover.

In an embodiment, some of the second weld beads may have a zigzag shape toward a center of the cover, or toward an opposite direction with respect to the center of the cover.

In an embodiment, the venting portion may further include a plurality of third weld beads having a weaker joining strength than that of the first weld beads, and a diameter of the third weld beads may be less than a diameter of the second weld beads.

In an embodiment, the case may further include an electrode terminal on one side surface of the body, and electrically connected to the electrode assembly. The cover may include a first portion overlapping with the electrode terminal in the first direction, and a second portion extending in a direction crossing the first portion. The venting portion may be in the second portion.

In an embodiment, a height of the venting portion in the first direction may be less than a length of the venting portion in a direction different from the first direction.

In an embodiment, the body and the cover may include a same metallic material as each other.

In an embodiment, the metallic material may include stainless use steel (SUS).

According to one or more embodiments of the present disclosure, a secondary battery includes: an electrode assembly including: a first electrode having a first electrode tab thereon; a second electrode having a second electrode tab thereon; and a separator between the first electrode and the second electrode; and a case accommodating the electrode assembly, the case including: a body including an accommodation portion having one opened end in a first direction to accommodate the electrode assembly, and a flange portion extending from the opened end in a direction different from the first direction; a cover welded to the flange portion to seal the opened end of the accommodation portion; and a welded portion of the flange portion and the cover. The welded portion includes a venting portion configured to be ruptured by an internal pressure of the accommodation portion sealed by the cover.

In an embodiment, a remaining portion of the welded portion, excluding the venting portion, may include a plurality of first weld beads, and the venting portion may include a plurality of second weld beads having a weaker joining strength than that of the first weld beads.

In an embodiment, some of the second weld beads may protrude toward a center of the cover, or may protrude toward an opposite direction with respect to the center of the cover.

In an embodiment, some of the second weld beads may have a zigzag shape toward a center of the cover, or toward an opposite direction with respect to the center of the cover.

In an embodiment, the venting portion may further include a plurality of third weld beads having a weaker joining strength than that of the first weld beads, and a diameter of the third weld beads may be less than a diameter of the second weld beads.

In an embodiment, a height of the venting portion in the first direction may be less than a length of the venting portion in a direction different from the first direction.

In an embodiment, the body and the cover may include a same metallic material as each other.

In an embodiment, the metallic material may include stainless use steel (SUS).

In an embodiment, the secondary battery may further include: a first electrode terminal on one side surface of the body, and electrically connected to the first electrode tab; and a second electrode terminal on the one side surface of the body, and electrically connected to the second electrode tab.

In an embodiment, the cover may include a first portion overlapping with the first and second electrode terminals of the body in the first direction, and a second portion extending in a direction crossing the first portion. The venting portion may be in the second portion.

In an embodiment, the welded portion may include a plurality of laser welds along a direction different from the first direction.

According to some embodiments of the present disclosure, a case for a secondary battery and a secondary battery including the case may be capable of preventing or substantially preventing a thermal runaway due to an increase in an internal pressure resulting from abnormal behavior (e.g., non-ideal behavior) of the secondary battery, without including or using separate additional processes.

According to some embodiments of the present disclosure, in a process of welding and sealing a cover and the case in which the electrode assembly of the secondary battery is accommodated to each other, a vent may be formed by partially changing (e.g., by only partially changing) a welding pattern.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a secondary battery according to some embodiments of the present disclosure.

FIG. 2 illustrates a portion of a cross-section of the secondary battery according to some embodiments of the present disclosure.

FIG. 3 illustrates a case of the secondary battery according to some embodiments of the present disclosure.

FIG. 4 illustrates a case of the secondary battery according to some embodiments of the present disclosure.

FIG. 5 illustrates a case for a secondary battery according to some embodiments of the present disclosure.

FIG. 6 illustrates a case for a secondary battery according to some embodiments of the present disclosure.

FIG. 7 illustrates a case for a secondary battery according to some embodiments of the present disclosure.

FIG. 8 illustrates a case for a secondary battery according to some embodiments of the present disclosure.

FIG. 9 illustrates an operation of welding the case of the secondary battery according to some embodiments of the present disclosure.

FIG. 10 illustrates an operation of cutting a flange portion according to some embodiments of the present disclosure

FIG. 11 illustrates a flowchart of an example of a method for manufacturing a secondary battery according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will be understood that when a component is referred to as being “linked,” “coupled,” or “connected” to another component, the elements may be directly “coupled,” “linked” or “connected” to each other, or another component may be “interposed”between the components”.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Throughout the specification, when “A and/or B” is stated, it means A, B or A and B, unless otherwise stated. In other words, “and/or” includes any or all combinations of a plurality of items enumerated. When “C to D” is stated, it means C or more and D or less, unless otherwise specified.

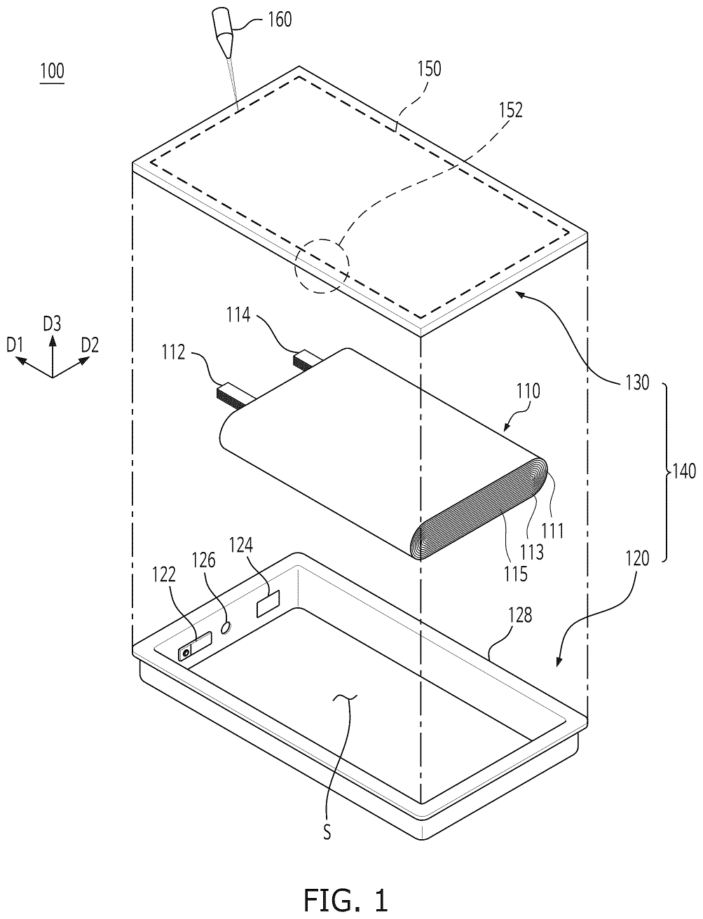

FIG. 1 illustrates a secondary battery 100 according to some embodiments of the present disclosure.

Referring to FIG. 1, the secondary battery 100 according to some embodiments of the present disclosure may include an electrode assembly 110, and a case 140 accommodating the electrode assembly 110. The electrode assembly 110 may include a first electrode 111 having a first electrode tab 112 formed thereon, a second electrode 113 having a second electrode tab 114 formed thereon, and a separator 115 between the first electrode 111 and the second electrode 113. The case 140 may include a body 120, a cover 130, and a welded portion 150. The body 120 may include an accommodation portion S having one opened end in a first direction D3 for accommodating the electrode assembly 110, and a flange portion 128 extending from the opened end in a direction different from the first direction D3 (e.g., in the direction D1 or the direction D2). The cover 130 may be welded to the flange portion 128 to seal the opened end of the accommodation portion S. The welded portion 150 may include a welded portion of the flange portion 128 and the cover 130. The welded portion 150 may include a venting portion 152 configured to be rupturable by an internal pressure (e.g., a predefined or predetermined internal pressure) of the sealed accommodation portion S.

According to an embodiment, the electrode assembly 110 may be wound or stacked with the separator 115, which is an insulator, provided between the first electrode 111 corresponding to a positive electrode and the second electrode 113 corresponding to a negative electrode. The secondary battery 100 shown in FIG. 1 may be a can-type secondary battery made of a stainless use steel (SUS) material, but the present disclosure is not limited thereto, and the secondary battery 100 may be any suitable one of various kinds of secondary batteries including, for example, a prismatic-type secondary battery made of an aluminum material.

The positive electrode and the negative electrode may include a coated portion, which is a region where an active material is applied to a current collector formed of a thin metal foil, and an uncoated portion, which is a region where no active material is coated. The positive electrode and the negative electrode may be wound with the separator, which is an insulator, provided therebetween. However, the present disclosure is not limited thereto, and the electrode assembly may have a stacked structure in which the negative electrode and the positive electrode each including a plurality of sheets are alternately stacked with the separator provided therebetween.

A positive electrode for a rechargeable lithium battery may include a current collector and a positive electrode active material layer on the current collector. The positive electrode active material layer may include a positive electrode active material and may further include a binder and/or a conductive material(e.g., an electrically conductive material).

For example, the positive electrode may further include an additive that can serve as a sacrificial positive electrode.

An amount of the positive electrode active material may be about 90 wt % to about 99.5 wt % based on 100 wt % of the positive electrode active material layer.

Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity(e.g., electrical conductivity) to the electrode. Any material that does not cause chemical change(e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

AI may be used as the current collector, but is not limited thereto.

Depending on the type of the rechargeable lithium battery, a separator may be present between the positive electrode and the negative electrode. The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The negative electrode for a rechargeable lithium battery may include a current collector and a negative electrode active material layer on the current collector. The negative electrode active material layer may include a negative electrode active material, and may further include a binder and/or a conductive material (e.g., an electrically conductive material).

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity(e.g., electrical conductivity) to the electrode. Any material that does not cause chemical change(e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

Depending on the type of the rechargeable lithium battery, a separator may be present between the positive electrode and the negative electrode. The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

The first electrode tab 112 and the second electrode tab 114 may be connected to the uncoated portions of the first electrode 111 and the second electrode 113, respectively, by welding, but may also be formed by punching the uncoated portions of the first electrode 111 and the second electrode 113. In the wound state, the first electrode tab 112 and the second electrode tab 114 may be arranged to be in parallel or substantially in parallel with each other with an interval (e.g., a certain or predetermined interval) therebetween. However, the present disclosure is not limited thereto, and in some embodiments, the electrode assembly 110 may have any suitable structure including electrode tabs.

The case 140 may form the overall exterior of the secondary battery 100, and may include (e.g., may be made of) a conductive metal, such as aluminum, an aluminum alloy, or a nickel-plated steel. According to an embodiment, the case 140 may include a metallic material, such as SUS, aluminum (Al), or the like. However, the present disclosure is not limited thereto, and the case 140 may include (e.g., may be composed of) various suitable metallic materials that satisfy a desired strength and a desired resistance to external impacts for the secondary battery 100.

In some embodiments, the case 140 may include the body 120, which may include the accommodation portion S having one opened end in the first direction D3 to accommodate the electrode assembly 110, and the flange portion 128 extending from the opened end in a direction different from the first direction D3 (e.g., in the direction D1 or the direction D2). The accommodation portion S of the body 120 may include an internal space in which the electrode assembly 110 is accommodated, and the internal space may be formed through press processing or the like. A planar shape of the accommodation portion S of the case 140 may be formed in, for example, a rectangular or an approximately rectangular shape. The case 140 may further include the cover 130 that is welded to the flange portion 128 to seal the opened end of the accommodation portion S. The cover 130 may include (e.g., may be composed of) a flat or substantially flat plate positioned above the case 140 to seal the accommodation portion S. For example, the cover 130 may be formed as a flat or substantially flat plate having a size that is sufficient to cover the flange portion 128, and may be in surface contact with the flange portion 128. In other words, the lower surface of the cover 130 and the upper surface of the flange portion 128 may be positioned to make surface contact with each other. By joining the flange portion 128 and the cover 130 to each other, the body 120 and the cover 130 may form a single bonded structure with each other. In an embodiment, the body 120 may be bonded to the cover 130 by laser welding. However, the present disclosure is not limited thereto, and various suitable bonding methods capable of sealing the case 140 may be used. For example, the cover 130 and the flange portion 128 may be bonded to each other by ultrasonic welding, brazing, laser brazing, welding, or soldering, as well as or instead of by the laser welding.

According to an embodiment, a first electrode terminal 122 electrically connected to the first electrode tab 112 of the electrode assembly 110 and a second electrode terminal 124 electrically connected to the second electrode tab 114 of the electrode assembly 110 may be joined to the body 120. For example, the first and second electrode terminals 122 and 124 may be positioned on at least one side surface of the case 140, or in more detail, on at least one side surface of the body 120. However, the positions of the first and second electrode terminals 122 and 124 according to embodiments of the present disclosure are not limited to the positions illustrated in FIG. 1, and may be variously modified as needed or desired.

The welded portion 150 may be formed by a welder 160 along the edge of the cover 130. For example, the welder 160 may include a laser welder. However, the positions of the welded portion 150 according to embodiments of the present disclosure are not limited to the positions illustrated in FIG. 1, and may be variously modified as needed or desired.

The venting portion 152 may be formed at any suitable position among the positions where the welded portion 150 is formed. For example, the cover 130 may include a first portion overlapping with the first and second electrode terminals 122 and 124 in the first direction D3, and a second portion extending in a direction crossing the first portion. The venting portion 152 may be formed in the second portion. The joining strength of the venting portion 152 may be weaker than the joining strength of the remaining portion of the welded portion 150 excluding the venting portion 152. The position and the shape of the venting portion 152 are described in more detail below.

By forming the venting portion 152 at a suitable position (e.g., an arbitrary or predetermined position) of the welded portion 150 as described above, a vent of the venting portion 152 may be formed by changing (e.g., by only changing) a portion of a welding pattern of the welded portion 150 during a process of welding and sealing the cover 130 and the case 140 accommodating the electrode assembly 110 of the secondary battery 100 to each other. In addition, the case for a secondary battery capable of preventing or substantially preventing a thermal runaway due to an increase in an internal pressure resulting from abnormal behavior (e.g., non-ideal behavior) of the secondary battery, without using or including separate additional processes in the process of manufacturing the secondary battery, and the secondary battery including the case, may be provided.

In an embodiment, the case 140 may include an electrolyte injection port 126. For example, the electrolyte injection port 126 may be a through-hole formed in at least one side surface of the case 140, and may be formed so that an electrolyte may be injected into the case 140 after the body 120 and the cover 130 are joined and sealed with each other. The electrolyte injection port 126 may be sealed with a sealing member after the electrolyte is injected.

The secondary battery 100 may be a lithium battery cell, a sodium battery cell, or the like. However, the present disclosure is not limited thereto, and the secondary battery 100 may include any suitable kind of battery that is capable of repeatedly providing electricity through charging and discharging. In an embodiment, if the secondary battery 100 is a lithium battery cell, the lithium battery cell may be used in electric vehicles (EVs) because of the lithium battery cell's excellent lifespan characteristics and high rate characteristics. For example, the lithium battery cell may be used in EVs, such as plug-in hybrid electric vehicles (PHEVs). In addition, the lithium battery cells may be used in a wider range of applications desiring or requiring power storage, for example, including smartphones, tablet PCs, electric bicycles, and power tools, but the present disclosure is not limited thereto.

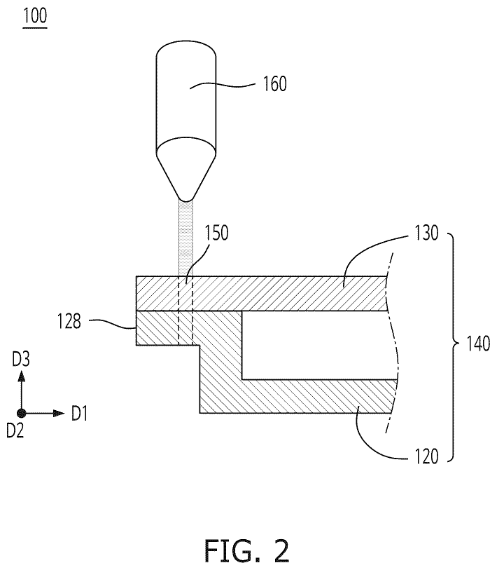

FIG. 2 illustrates a portion of a cross-section of the secondary battery 100 according to some embodiments of the present disclosure.

Referring to FIG. 2, the body 120 and the cover 130 of the secondary battery 100 may be welded to each other to form the case 140, which may be a single bonded structure. An edge or an outermost region of the cover 130 may be welded to the flange portion 128 of the body 120 through the welder 160. For example, the cover 130 and the flange portion 128 may be welded together through laser welding.

The welded portion 150 may be formed through the welding of the cover 130 and the flange portion 128 to each other. The welded portion 150 may include portions that are connected to each other in the first direction D3 by overlapping with each of the cover 130 and the flange portion 128 through welding. A length of the welded portion 150 in a second direction D1 may be less than a length of a region in the second direction D1 where the flange portion 128 and the cover 130 overlap with each other in the first direction D3. The welded portion 150 may have different joining strengths according to the welded portion or position. As such, the welder 160 may be controlled to generate weld beads having different joining strengths at different positions in the welded portion 150.

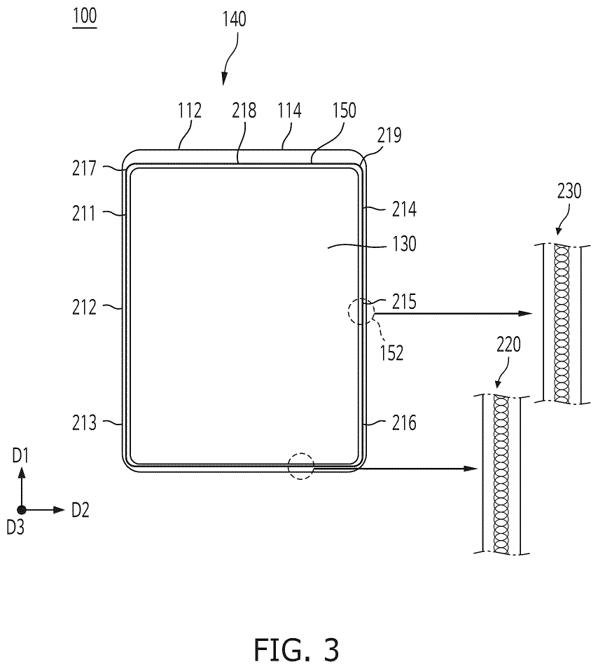

FIG. 3 illustrates the case 140 of the secondary battery 100 according to some embodiments of the present disclosure.

Referring to FIG. 3, the welded portion 150 may be formed on the cover 130 of the case 140 of the secondary battery 100. In an embodiment, the welded portion 150 may be formed along the edge or the outermost region of the cover 130. The venting portion 152 may be formed at any suitable position among the positions where the welded portion 150 is formed. For example, the venting portion 152 may be formed in at least one of a first position 211, a second position 212, a third position 213, a fourth position 214, a fifth position 215, a sixth position 216, a seventh position 217, an eighth position 218, and/or a ninth position 219. The venting portion 152 may be configured to be ruptured by a pressure (e.g., a predefined or predetermined pressure) inside the case 140. In other words, the venting portion 152 may be ruptured if the pressure inside the case 140 exceeds a threshold pressure. The case 140 of the secondary battery 100 may have a rectangular shape that is longer in the second direction D1. In a case where a swelling phenomenon occurs, the case 140 may swell from the center thereof. In this case, the venting portion 152 formed at the second position 212 or the fifth position 215 may be ruptured at a lower internal pressure than that of the venting portion 152 formed at other positions. On the other hand, in a case where the venting portion 152 formed on the seventh position 217, the eighth position 218, and/or the ninth position 219 is ruptured, the first and second electrode tabs 112 and 114 positioned at positions close (e.g., adjacent) thereto may be damaged. Therefore, in a case where the venting portion 152 is formed at the second position 212 or the fifth position 215, the thermal runaway phenomenon of the secondary battery 100 may be prevented or substantially prevented more effectively. The second position 212 or the fifth position 215 may correspond to the second portion of the cover 130 described above with reference to FIG. 1.

According to an embodiment, the remaining portion of the welded portion 150 excluding the venting portion 152 may include a plurality of first weld beads 220, and the venting portion 152 may include a plurality of second weld beads 230 having a weaker joining strength than that of the first weld beads 220. For example, when comparing a section in which the second weld beads 230 of the venting portion 152 are formed and a section in which the first weld beads 220 are formed in the remaining portion of the welded portion 150 having the same or substantially the same length as each other, the number of the second weld beads 230 may be formed to be smaller than the number of the first weld beads 220. Thus, the second weld beads 230 may have a weaker joining strength than that of the first weld beads 220. The first weld beads 220 and the second weld beads 230 may be spaced apart from the edge of the cover 130 by a suitable distance (e.g., a certain or predetermined distance). The height of the second weld beads 230 of the venting portion 152 in the first direction D3 may be less than the length of the second weld beads 230 of the venting portion 152 formed in a direction different from the first direction D3 (e.g., formed in the direction D1 or the direction D2).

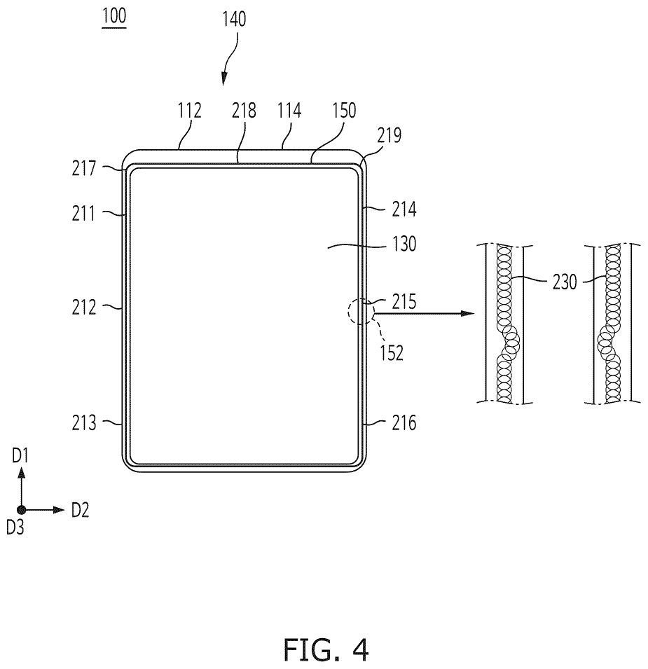

FIG. 4 illustrates the case 140 of the secondary battery 100 according to some embodiments of the present disclosure. Hereinafter with reference to FIG. 4, description of the same or substantially the same configurations and components as those described above with reference to FIGS. 1 to 3 may not be repeated.

Referring to FIG. 4, some of the second weld beads 230 may protrude toward the center of the cover 130, or may protrude toward an opposite direction with respect to the center of the cover 130. In other words, some of the second weld beads 230 may be formed in a concave shape or a convex shape with respect to the center of the cover 130. Some of the second weld beads 230 formed in a concave shape or a convex shape may have a weaker joining strength than that of the remaining portions of the second weld beads 230. In a case where a protruding portion of the second weld beads 230 protrudes toward the center of the cover 130 or towards the opposite direction with respect to the center, the second weld beads 230 may be spaced apart from the edge of the cover 130 by a suitable distance (e.g., a certain or predetermined distance).

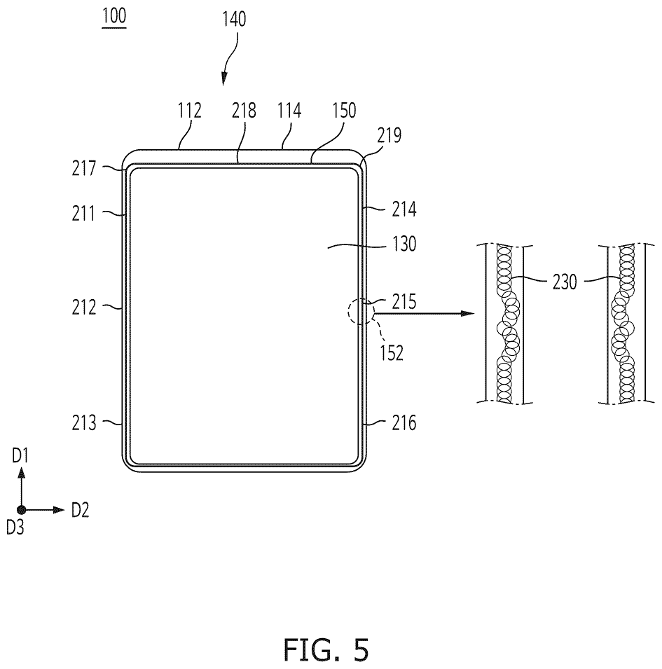

FIG. 5 illustrates a case for a secondary battery according to some embodiments of the present disclosure. Hereinafter with reference to FIG. 5, description of the same or substantially the same configurations and components as those described above with reference to FIGS. 1 to 4 may not be repeated.

Referring to FIG. 5, some of the second weld beads 230 may be formed in a zigzag shape toward the center of the cover 130 or in the opposite direction with respect to the center of the cover 130. Some of the second weld beads 230 formed in the zigzag shape may have a weaker joining strength than that of the remaining portions of the second weld beads 230. For example, some of the second weld beads 230 may protrude toward the center of the cover 130, and others of the second weld beads 230 may protrude toward the center of the cover 130, thereby forming a zigzag shape. For example, some of the second weld beads 230 may protrude toward the opposite direction with respect to the center of the cover 130, and others of the second weld beads 230 may protrude toward the opposite direction with respect to the center of the cover 130, thereby forming a zigzag shape. For example, some of the second weld beads 230 may protrude toward the center of the cover 130, and others of the second weld beads 230 may protrude toward the opposite direction with respect to the center of the cover 130, thereby forming a zigzag shape. The zigzag shape may be formed at any suitable position on the second weld beads 230 of the venting portion 152.

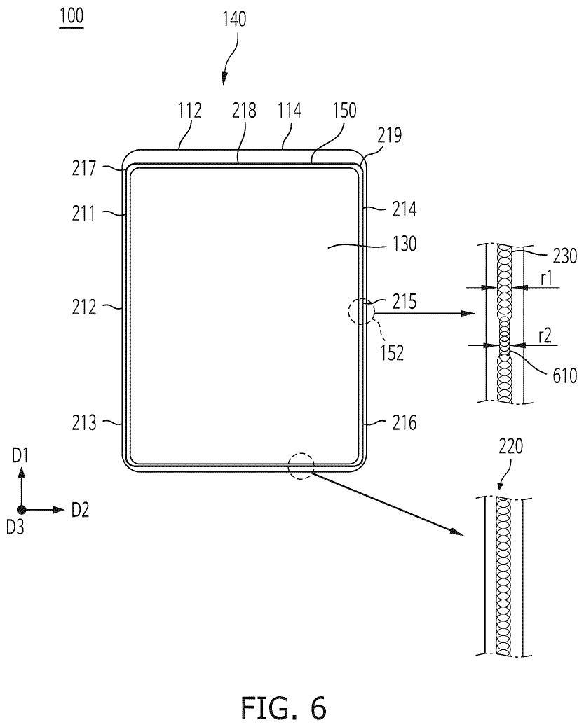

FIG. 6 illustrates a case for a secondary battery according to some embodiments of the present disclosure. Hereinafter with reference to FIG. 6, description of the same or substantially the same configurations and components as those described above with reference to FIGS. 1 to 5 may not be repeated.

Referring to FIG. 6, the venting portion 152 may further include a plurality of third weld beads 610 having a weaker joining strength than that of the first weld beads 220. In this case, a diameter r2 of the third weld beads 610 may be less than a diameter r1 of the second weld beads 230. Because the venting portion 152 may further include the plurality of third weld beads 610 having a diameter r2 smaller than the diameter r1 of the second weld beads 230, a rupture may occur more easily than in a case where only the second weld beads 230 are included, thereby effectively preventing the thermal runaway phenomenon of the secondary battery 100.

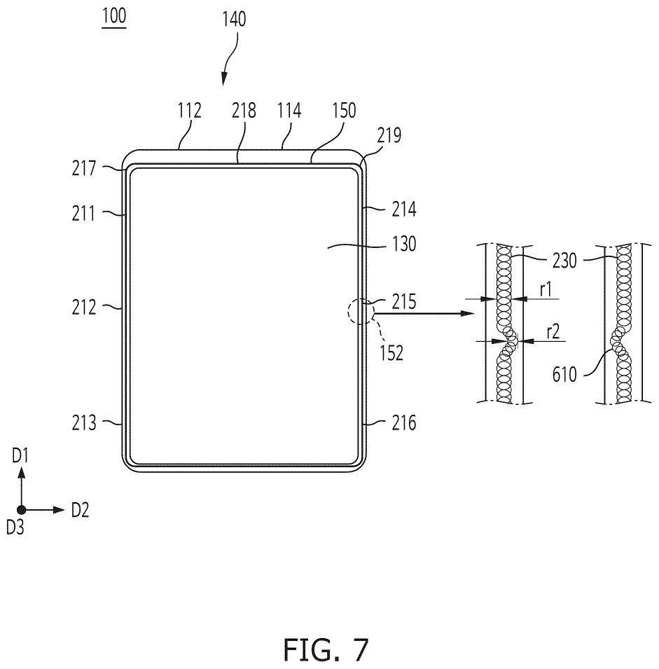

FIG. 7 illustrates a case for a secondary battery according to some embodiments of the present disclosure. Hereinafter with reference to FIG. 7, description of the same or substantially the same configurations and components as those described above with reference to FIGS. 1 to 6 may not be repeated.

Referring to FIG. 7, some of the third weld beads 610 may protrude toward the center of the cover 130, or toward the opposite direction with respect to the center of the cover 130. In other words, some of the third weld beads 610 may be formed in a concave shape or in a convex shape from the center of the cover 130. In a case where a protruding portion of the third weld beads 610 protrudes toward the center of the cover 130 or toward the opposite direction with respect to the center, the third weld beads 610 may be spaced apart from the edge of the cover 130 by a suitable distance (e.g., a certain or predetermined distance).

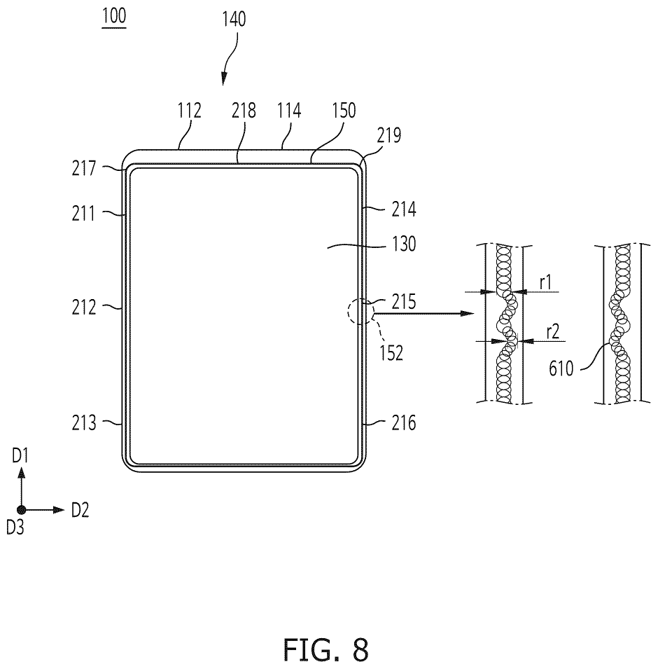

FIG. 8 illustrates a case for a secondary battery according to some embodiments of the present disclosure. Hereinafter with reference to FIG. 8, description of the same or substantially the same configurations and components as those described above with reference to FIGS. 1 to 7 may not be repeated.

Referring to FIG. 8, some of the third weld beads 610 may be formed in a zigzag shape toward the center of the cover 130 or toward the opposite direction with respect to the center of the cover 130. For example, some of the third weld beads 610 may protrude toward the center of the cover 130, and others of the third weld beads 610 may protrude toward the center of the cover 130, thereby forming a zigzag shape. For example, some of the third weld beads 610 may protrude toward the opposite direction with respect to the center of the cover 130, and others of the third weld beads 610 may protrude toward the opposite direction with respect to the center of the cover 130, thereby forming a zigzag shape. For example, some of the third weld beads 610 may protrude toward the center of the cover 130, and others of the third weld beads 610 may protrude toward the opposite direction with respect to the center of the cover 130, thereby forming a zigzag shape. The zigzag shape may be formed at any suitable position on the third weld beads 610 of the venting portion 152.

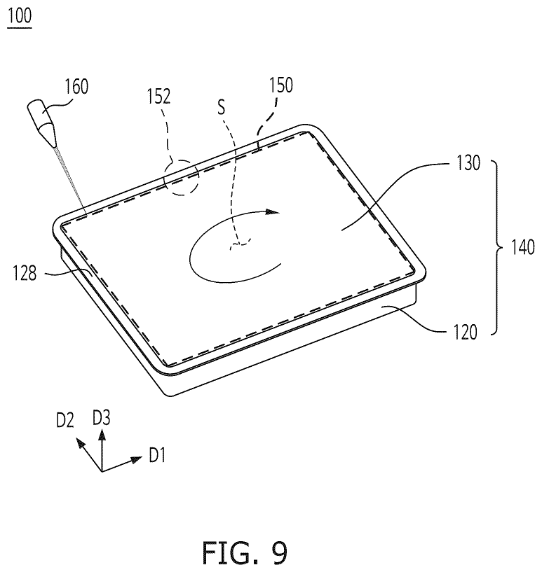

FIG. 9 illustrates an operation of welding the case 140 of the secondary battery 100 according to some embodiments of the present disclosure. Hereinafter with reference to FIG. 9, description of the same or substantially the same configurations and components as those described above with reference to FIGS. 1 and 2 may not be repeated.

Referring to FIG. 9, the cover 130 positioned above the case 140 to seal the accommodation portion S may be joined to the flange portion 128. For example, the cover 130 may be joined to the flange portion 128 by using the welder 160. The cover 130 and the flange portion 128 may be joined together through laser welding. According to an embodiment, the welding may proceed in a clockwise direction along a line indicated by a dashed line in FIG. 9 around the circumference of the flange portion 128, but the present disclosure is not limited thereto.

According to an embodiment, the welded portion 150 may be formed through the laser welding performed a plurality of times in a direction different from the first direction D3 (e.g., in the direction D1 or the direction D2). For example, the remaining portion of the welded portion 150 excluding the venting portion 152 may be welded to form the first weld beads 220 as described above with reference to FIG. 3, and then the second weld beads 230 as described above with reference to FIGS. 3 to 5 may be welded by welding the venting portion 152. For example, the remaining portion of the welded portion 150 excluding the venting portion 152 may be welded to form the first weld beads 220 as described above with reference to FIG. 3, and then the venting portion 152 may be welded by adjusting the distance between the welder 161 and the secondary battery 100 in the first direction D3, thereby forming the third weld beads 610 as described above with reference to FIGS. 6 to 8.

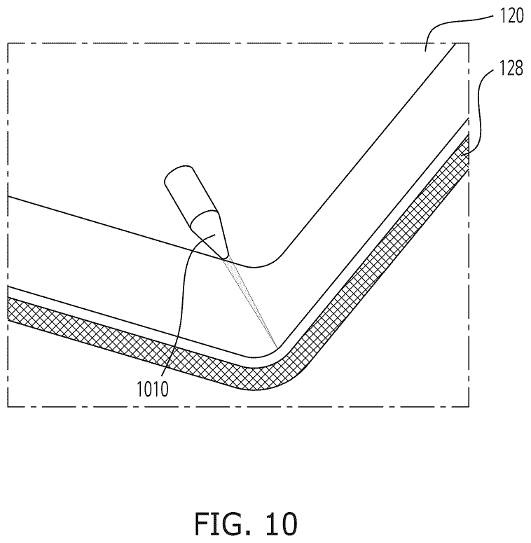

FIG. 10 illustrates an operation of cutting the flange portion 128 according to some embodiments of the present disclosure.

Referring to FIG. 10, after the cover 130 is joined to the flange portion 128 by using the welder 160 as described above with reference to FIG. 9, the outermost region of the flange portion 128 (e.g., at least a portion of the outer region of the welded portion 150) may be cut. According to an embodiment, the flange portion 128 may be cut by using a cutter 1010. The cutter 1010 may be, for example, a laser cutter. The flange portion 128 may be cut to an extent extending from the body 120, but the present disclosure is not limited thereto.

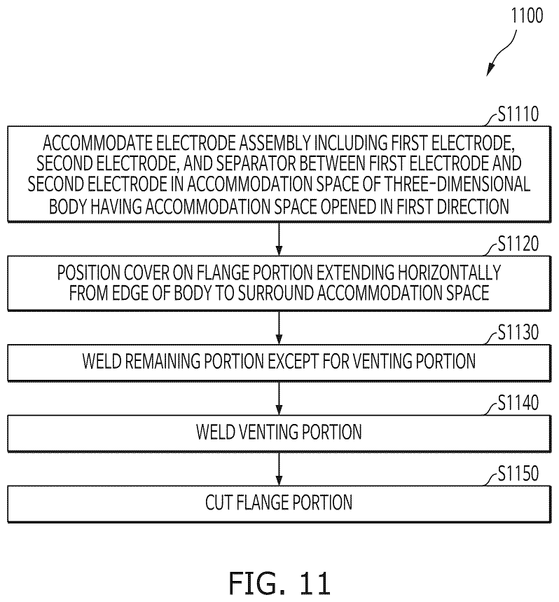

FIG. 11 illustrates a flowchart of an example of a method for manufacturing a secondary battery according to some embodiments of the present disclosure.

Referring to FIG. 11, a method 1100 for manufacturing a secondary battery may start, and an electrode assembly including a first electrode, a second electrode, and a separator between the first electrode and the second electrode may be accommodated in an accommodation space of a three-dimensional body having the accommodation space opened in a first direction (S1110). For example, referring to FIG. 1, the accommodation space may refer to the accommodation portion S of the body 120 opened in the first direction D3, and the electrode assembly 110 may be accommodated therein.

The cover may be positioned on the flange portion extending horizontally from the edge of the body to surround the accommodation space (S1120). For example, referring to FIG. 1, the cover 130 may be positioned on the flange portion 128 extending from the edge of the body 120 to surround the accommodation portion S.

A remaining portion except for a venting portion may be welded (S1130), and the venting portion may be welded (S1140). For example, referring to FIGS. 1 and 2, the remaining portion except for the venting portion 152 may be welded, and then the venting portion 152 may be welded to form the welded portion 150. By forming the welded portion 150, the body 120 and the cover 130 may form the case 140. The case 140 may include (e.g., may be made of) a metallic material. For example, the metallic material may include SUS.

The flange portion may be cut (S1150). For example, referring to FIG. 1 and FIG. 10, the secondary battery 100 described above with reference to FIG. 1 may be manufactured by cutting the flange portion 128.

According to the method 1100 described above, in the process of welding and sealing the cover and the case in which the electrode assembly of the secondary battery is accommodated to each other, the vent may be formed by partially changing (e.g., by only partially changing) the welding pattern. In addition, the case for a secondary battery capable of preventing or substantially preventing a thermal runaway due to an increase in an internal pressure resulting from abnormal behavior (e.g., non-ideal behavior) of the secondary battery, without using or including separate additional processes, and the secondary battery including the case, may be provided.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A case for a secondary battery, the case comprising:
a body comprising an accommodation portion having one opened end in a first direction to accommodate an electrode assembly, and a flange portion extending from the opened end in a direction different from the first direction;
a cover welded to the flange portion to seal the opened end of the accommodation portion; and
a welded portion of the flange portion and the cover,
wherein the welded portion comprises a venting portion configured to be ruptured by an internal pressure of the accommodation portion sealed by the cover.

2. The case as claimed in claim 1, wherein a remaining portion of the welded portion, excluding the venting portion, comprises a plurality of first weld beads, and
wherein the venting portion comprises a plurality of second weld beads having a weaker joining strength than that of the first weld beads.

3. The case as claimed in claim 2, wherein some of the second weld beads protrude toward a center of the cover, or protrude in an opposite direction with respect to the center of the cover.

4. The case as claimed in claim 2, wherein some of the second weld beads have a zigzag shape toward a center of the cover, or toward an opposite direction with respect to the center of the cover.

5. The case as claimed in claim 2, wherein the venting portion further comprises a plurality of third weld beads having a weaker joining strength than that of the first weld beads, and
wherein a diameter of the third weld beads is less than a diameter of the second weld beads.

6. The case as claimed in claim 1, further comprising an electrode terminal on one side surface of the body, and electrically connected to the electrode assembly,
wherein the cover comprises a first portion overlapping with the electrode terminal in the first direction, and a second portion extending in a direction crossing the first portion, and
wherein the venting portion is in the second portion.

7. The case as claimed in claim 1, wherein a height of the venting portion in the first direction is less than a length of the venting portion in a direction different from the first direction.

8. The case as claimed in claim 1, wherein the body and the cover comprise a same metallic material as each other.

9. The case as claimed in claim 8, wherein the metallic material comprises stainless use steel (SUS).

10. A secondary battery comprising:
an electrode assembly comprising:
a first electrode having a first electrode tab thereon;
a second electrode having a second electrode tab thereon; and
a separator between the first electrode and the second electrode; and
a case accommodating the electrode assembly, the case comprising:
a body comprising an accommodation portion having one opened end in a first direction to accommodate the electrode assembly, and a flange portion extending from the opened end in a direction different from the first direction;
a cover welded to the flange portion to seal the opened end of the accommodation portion; and
a welded portion of the flange portion and the cover,
wherein the welded portion comprises a venting portion configured to be ruptured by an internal pressure of the accommodation portion sealed by the cover.

11. The secondary battery as claimed in claim 10, wherein a remaining portion of the welded portion, excluding the venting portion, comprises a plurality of first weld beads, and
wherein the venting portion comprises a plurality of second weld beads having a weaker joining strength than that of the first weld beads.

12. The secondary battery as claimed in claim 11, wherein some of the second weld beads protrude toward a center of the cover, or protrude toward an opposite direction with respect to the center of the cover.

13. The secondary battery as claimed in claim 11, wherein some of the second weld beads have a zigzag shape toward a center of the cover, or toward an opposite direction with respect to the center of the cover.

14. The secondary battery as claimed in claim 11, wherein the venting portion further comprises a plurality of third weld beads having a weaker joining strength than that of the first weld beads, and
wherein a diameter of the third weld beads is less than a diameter of the second weld beads.

15. The secondary battery as claimed in claim 10, wherein a height of the venting portion in the first direction is less than a length of the venting portion in a direction different from the first direction.

16. The secondary battery as claimed in claim 10, wherein the body and the cover comprise a same metallic material as each other.

17. The secondary battery as claimed in claim 16, wherein the metallic material comprises stainless use steel (SUS).

18. The secondary battery as claimed in claim 10, further comprising:
a first electrode terminal on one side surface of the body, and electrically connected to the first electrode tab; and
a second electrode terminal on the one side surface of the body, and electrically connected to the second electrode tab.

19. The secondary battery as claimed in claim 18, wherein the cover comprises a first portion overlapping with the first and second electrode terminals of the body in the first direction, and a second portion extending in a direction crossing the first portion, and
wherein the venting portion is in the second portion.

20. The secondary battery as claimed in claim 10, wherein the welded portion comprises a plurality of laser welds along a direction different from the first direction.
